(19) United States
(12) Patent Application Publication
(10) Pub. No.: US 2025/0286200 A1
(43) Pub. Date: Sep. 11, 2025

(54) BATTERY SYSTEM WITH IMPROVED CELL SPACERS

(71) Applicant: SAMSUNG SDI CO., LTD., Yongin-si (KR)

(72) Inventor: Eymen IPEK, Graz (AT)

(21) Appl. No.: 18/740,347

(22) Filed: Jun. 11, 2024

(30) Foreign Application Priority Data
Mar. 6, 2024 (EP) 24161783.6

(51) Int. Cl. H01M 50/291; B60L 50/60; H01M 50/209; H01M 50/249

(52) U.S. Cl. CPC H01M 50/291; B60L 50/60; H01M 50/209; H01M 50/249; H01M 2220/20

(57) ABSTRACT

A battery system includes a plurality of battery cells arranged along an alignment axis; and a cell spacer in a gap between adjacent ones of the battery cells, the cell spacer including a center portion and border portions adjoining the center portion, the center portion having a greater thickness than the adjoining border portions, wherein opposite outer surfaces of the cell spacer are arranged at the same distance but in opposite directions from a central plane, the central plane being perpendicular to the alignment axis and extending through the center portion and border portions.

### CROSS-REFERENCE TO RELATED APPLICATION

This application claims priority to and the benefit of European Patent application Ser. No. 24161783.6, filed on Mar. 6, 2024, in the European Union Intellectual Property Office, the disclosure of which is incorporated herein in its entirety by reference.

### FIELD OF THE DISCLOSURE

Aspects of the present disclosure relate to a battery system and a vehicle including the same.

### BACKGROUND

Recently, vehicles for transportation of goods and people have been developed that use electric power as a source for motion. Such an electric vehicle is an automobile that is propelled by an electric motor, using energy stored in rechargeable batteries. An electric vehicle may be solely powered by batteries (such as in a battery electric vehicle (BEV)) or may include a combination of an electric motor and, for example, a conventional combustion engine (such as in a plugin hybrid electric vehicle (PHEV)). BEVs and PHEVs use high-capacity rechargeable batteries, which are designed to provide power for propulsion over sustained periods of time.

A single battery cell includes an electrode assembly including a positive electrode, a negative electrode, and a separator interposed between the electrodes. A solid or liquid electrolyte allows movement of ions during charging and discharging of the battery cell. The electrode assembly is located in a casing and electrode terminals, which are positioned on the outside of the casing, establish an electrically conductive connection to the electrodes. The shape of the casing may be, for example, cylindrical or rectangular.

A battery module is formed of a plurality of battery cells connected together in series and/or in parallel. That is, the battery module is formed by interconnecting the electrode terminals of the plurality of battery cells depending on a desired amount of power and in order to realize a high-power rechargeable battery.

Battery modules can be constructed either in a block design or in a modular design. In the block design each battery is coupled to a common current collector structure and a common battery management system and the unit thereof is arranged in a housing. In the modular design, pluralities of battery cells are connected together to form submodules and several submodules are connected together to form the battery module. In automotive applications, battery systems generally include a plurality of battery modules connected together in series to provide a desired voltage.

A battery pack is a set of any number of battery modules (e.g., identical battery modules) or single battery cells. The battery modules or battery cells may be configured in a series, parallel or a mixture of both to deliver the desired voltage, capacity, or power density. Components of battery packs include the individual battery modules, and the interconnects, which provide electrical conductivity between them.

To ensure proper thermal control of the battery pack, a thermal management system may be utilized to safely use the at least one battery module by efficiently emitting, discharging, and/or dissipating heat generated from its rechargeable batteries. If the heat emission/discharge/dissipation is not sufficiently performed, temperature deviations occur between different battery cells, which may lead to the battery module not being able to generate a desired amount of power. In addition, an increase of the internal temperature can lead to abnormal reactions occurring therein and thus charging and discharging performance of the rechargeable battery deteriorates and the life-span of the rechargeable battery is shortened. Thus, cell cooling for effectively emitting/discharging/dissipating heat from the cells is desirable.

Exothermic decomposition of cell components may lead to a so-called thermal runaway. In general, thermal runaway describes a process that is accelerated by increased temperature, in turn releasing energy that further increases temperature. Thermal runaway occurs in situations where an increase in temperature changes the conditions in a way that causes a further increase in temperature, often leading to a destructive result. In rechargeable battery systems, thermal runaway is associated with strongly exothermic reactions that are accelerated by temperature rise. In thermal runaway, the battery cell temperature rises incredibly fast and the energy stored is released very suddenly. In extreme cases, thermal runaway can cause battery cells to explode and start a fire. In other cases, it can cause battery cells to be damaged beyond repair.

When a battery cell is heated above a critical temperature (e.g., above 150° C.) it can transit into a thermal runaway state. Generally, temperatures outside of the safe region on either the low or high side may lead to irreversible damage to the battery and therefore may possibly trigger thermal runaway. Thermal runaway may also occur due to an internal or external short circuit of the battery or poor battery maintenance. For example, overcharging or rapid charging may lead to thermal runaway.

During thermal runaway, the failed battery cell may reach a temperature exceeding 700° C. Further, large quantities of hot gas are ejected from inside of the failed battery cell through the venting opening of the cell housing into the battery pack.

The main components of the vented gas are H₂, CO₂, CO, electrolyte vapor and other hydrocarbons. The vented gas is therefore burnable and potentially toxic. The vented gas also causes a gas-pressure to increase inside the battery pack. In the worst case scenario, the high temperatures lead to the process spreading to neighboring cells and causing a fire in the battery pack. At this stage, the fire is may be difficult to extinguish.

A battery system may include multiple battery cells that are separated from one another via cell spacers. Such cell spacers are used to limit thermal conduction between adjacent battery cells, in particular between faulty and healthy battery cells, for example, during a thermal runaway. In the related art, cell spacers are designed as simple uniform shapes, in particular as cuboid shapes with a rectangular or substantially rectangular cross-section, similar to the shape of the battery cells.

During their lifetime the battery cells of a battery system are charged and discharged numerous times, wherein the battery cells swell up, that is, increase in thickness and thus volume, during charging, and shrink, that is, decrease in thickness and thus volume, during discharging. This kind of cyclic volume change is called cell breathing. Due to this cell breathing the cell spacers are deformed have their thickness reduced in particular in their middle section as this is usually where the adjacent battery cells exert the most pressure/force. As the cell spacers thin out, the distance between the adjacent battery cells may be reduced so that they can no longer sufficiently perform their purpose of limiting thermal conduction between adjacent battery cells. Also, the structural integrity of the battery system may be compromised as the cell spacers no longer sufficiently keep the battery cells in place.

The above information disclosed in this Background section is only for enhancement of understanding of the background of the invention and therefore it may contain information that does not form the prior art.

### SUMMARY OF INVENTION

Aspects of embodiments of the present disclosure are directed to overcoming or reducing at least some of the drawbacks of the prior art and to provide a battery system in which the battery cells are sufficiently thermally isolated from each other over many breathing cycles thereby prolonging the lifetime of the battery system.

According to some embodiments of the present disclosure, there is provided a battery system including: a plurality of battery cells arranged along an alignment axis;

and a cell spacer in a gap between adjacent ones of the battery cells, the cell spacer including a center portion and border portions adjoining the center portion, the center portion having a greater thickness than the adjoining border portions, wherein opposite outer surfaces of the cell spacer are arranged at the same distance but in opposite directions from a central plane, the central plane being perpendicular to the alignment axis and extending through the center portion and border portions.

In some embodiments, the cell spacer has a mirror-symmetrical shape.

In some embodiments, the thickness of the cell spacer decreases continuously from the center portion to each of the border portions.

In some embodiments, the cell spacer has an elliptical cross-section.

In some embodiments, the thickness of the cell spacer decreases in steps from the center portion to each of the border portions.

According to some embodiments of the present disclosure, there is provided an electric vehicle including said battery system.

### BRIEF DESCRIPTION OF THE DRAWINGS

Features will become apparent to those of ordinary skill in the art by describing in detail exemplary embodiments with reference to the attached drawings in which:

FIG. 1 is a schematic cross-sectional view of a battery system with a swollen battery cell according to some examples.

FIG. 2 is a schematic cross-sectional view of a battery system with deformed cell spacers according to some examples.

FIG. 3 is a schematic perspective view of a cell spacer according to some embodiments of the present disclosure.

FIG. 4 is a schematic cross-sectional view of the battery system with cell spacers shown in FIG. 3, according to some embodiments of the present disclosure.

FIG. 5 is a schematic cross-sectional view of a battery system with cell spacers according to some other embodiments of present disclosure.

FIG. 6 is a schematic cross-sectional view of the battery system shown in FIG. 4 or FIG. 5 at an end of life stage, according to some embodiments of the present disclosure.

### DETAILED DESCRIPTION OF THE INVENTION

Reference will now be made in detail to embodiments, examples of which are illustrated in the accompanying drawings. Effects and features of the exemplary embodiments, and implementation methods thereof will be described with reference to the accompanying drawings. In the drawings, like reference numerals denote like elements, and redundant descriptions are omitted. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described. In the drawings, the relative sizes of elements, layers, and regions may be exaggerated for clarity.

As used herein, the term “and/or” includes any and all combinations of one or more of the associated listed items. Further, the use of “may” when describing embodiments of the present disclosure refers to “one or more embodiments of the present disclosure.” In the following description of embodiments of the present disclosure, the terms of a singular form may include plural forms unless the context clearly indicates otherwise.

It will be understood that although the terms “first” and “second” are used to describe various elements, these elements should not be limited by these terms. These terms are only used to distinguish one element from another element. For example, a first element may be named a second element and, similarly, a second element may be named a first element, without departing from the scope of the present disclosure. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

It will also be understood that when a film, a region, or an element is referred to as being “above” or “on” another film, region, or element, it can be directly on the other film, region, or element, or intervening films, regions, or elements may also be present.

Herein, the terms “upper” and “lower” are defined according to the z-axis. For example, the upper cover is positioned at the upper part of the z-axis, whereas the lower cover is positioned at the lower part thereof. In the drawings, the sizes of elements may be exaggerated for clarity. For example, in the drawings, the size or thickness of each element may be arbitrarily shown for illustrative purposes, and thus the embodiments of the present disclosure should not be construed as being limited thereto.

In the following description of embodiments of the present disclosure, the terms of a singular form may include plural forms unless the context clearly indicates otherwise.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to some aspects of the present disclosure, a battery system is provided. The battery system includes a plurality of battery cells, such as prismatic battery cells. The battery system may include a housing accommodating the battery cells. The battery cells within each battery pack may be interconnected via electrical connecting means, for example, busbars, contacting respective electrode/cell terminals of the battery cells. The battery cells are arranged to form one or more battery packs, wherein in a battery pack the battery cells are electrically interconnected for example, in a series and/or in parallel as explained above. Multiple of the battery cell within a battery pack may form a battery module. Two or more of the battery modules may be stacked to form cell stacks. The battery cells are preferably prismatic battery cells.

The battery cells may be arranged along an alignment axis. For example, the battery cells may be stacked along said axis. Between two neighboring/adjacent battery cells a cell spacer is arranged. Thus, a cell spacer is disposed in each gap between adjacent ones of the battery cells. As such, adjacent battery cells are separated from each other via a cell spacer. The battery system may include a plurality of battery cells and cell spacers, and the battery cells and cell spacers may be alternately arranged or stacked along the alignment direction. The battery system includes at least two battery cells and one cell spacer arranged in between the two battery cells. The cell spacer separates or spaces apart adjacent battery cells from each other. The cell spacer also holds the battery cells in place by keeping them at a set or predefined distance from one another and limits thermal conduction between the adjacent battery cells, for example, during a thermal runaway of one of the battery cells.

According to some embodiments of the present disclosure, the cell spacer includes a center portion and adjoining border portions. The center portion has a greater thickness than the adjoining border portions. In other, words, the center portion is thicker than the border portions. The center portion refers to a portion/section of the cell spacer that is arranged in the middle area of the cell spacer, the center portion to the sides transitioning into the border portions. When the battery system is mounted/installed in an electric vehicle, the border portions may consist of an upper border portion and a lower border portion. The thickness of the cell spacer denotes the extension of the cell spacer along the alignment axis, and refers to the distance between two opposite outer surfaces of the cell spacer along the alignment axis. The opposite outer surfaces of the cell spacer are arranged at the same distance, but in opposite directions, from a central plane which is perpendicular to the alignment axis and which extends through the center portion and border portions plane in opposite directions. In other words, the cell spacer has two opposite outer surfaces of the cell spacer which are distanced from the central plane by a first distance but in opposite directions along the alignment axis such that a distance between the two opposite outer surfaces is two times the first distance. This distance between the two opposite outer surfaces (i.e., twice the first distance) is the thickness of the cell spacer. Thus, the distance from the central plane the outer surfaces are arranged at is larger at the central portion than at the border portions.

During a breathing cycle, the battery cells of the battery system may swell up and thus exert a pressure/force onto the adjacent cell spacers, as explained above. As the battery cells usually exert a larger force or pressure at their center than at the edges, the center portion of the cell spacer according to some embodiments is compressed more than the border portions. As the cell spacers according to some embodiments of the present disclosure are thicker at their center portion than at their border portions and because of the same distancing of the opposite outer surfaces from the central plane, the cell spacers more evenly distribute the forces received by the adjacent battery cells. The cell spacers according to some embodiments of the present disclosure may therefore better withstand these forces.

Further, while the cell spacer according to some embodiments of the present disclosure may get deformed by the swollen battery cells after a large number of breathing cycles, the cell spacer gets deformed into a more suitable shape than known cell spacers. Due to the more evenly distributed forces received by the adjacent battery cells, the cell cover may be flattened. That is, the cell spacer is deformed such that material from the center portion is moved (e.g., is pushed) to the border portions such that the difference in thickness between the center portion and the border portions is at least partly compensated over time. After numerous breathing cycles the shape of the cell spacers according to some embodiments of the present disclosure may be transformed to a shape that is rather cuboid with a rectangular or substantially rectangular cross-section similar to the above-discussed cell spacers. In this shape, the cell spacers may still perform their intended purpose of distancing the battery cells and limiting thermal conduction between the battery cells as the deformed cell spacer contact the adjacent battery cells basically over their whole surface. Compared to known cell spacers, the contact area between the cell spacer and the adjacent battery cells is not reduced over time but possibly even enlarged. The cell spacer, thus, ensures that the distance between two adjacent/neighboring battery cells does not fall below a set or predefined minimum distance.

Thus, in summary, the battery system according to some embodiments of the present disclosure allows for the cell spacers to sufficiently perform their intended purpose of distancing the battery cells and limiting thermal conduction between the battery cells even after numerous breathing cycles. As a result, with the cell spacers of the battery system according to some embodiments of the present disclosure the battery cells are thermally isolated from each other over many breathing cycles. Here, the cell spacers may maintain a stable thermal resistance over the lifetime of the battery system. The time of life of the battery system may even be prolonged by these cell spacers.

According to some embodiments, the cell spacer has a mirror-symmetrical shape. That is, a mirror symmetry plane may exist for the cell spacer, such that a reflection at this plane is a symmetry operation of the cell spacer. In other words, the cell spacer may be an object for which every point has a one-to-one mapping onto another point equidistant from and on opposite sides of a common plane, which is the mirror symmetry plane. The mirror symmetry plane is a plane perpendicular to the alignment axis. The mirror symmetry plane is the central plane. When the cell spacer is mirror-symmetrical, the outer surface of the cell spacer is distanced the same amount from the mirror symmetry plane in opposite directions. Thus, there are at least two outer surfaces of the cell spacer which extend the same distance but in opposite directions from the central plane, that is, the mirror symmetry plane, the plane being perpendicular to the alignment axis and extending through the center portion and border portions. The cell spacer of such a shape is particularly suited to maintain a sufficient distance between adjacent battery cells likely because the external pressure applied by the adjacent battery cells is uniformly distributed along the surface and inside the cell spacer.

According to some embodiments, the thickness of the cell spacer decreases continuously from the center portion to each of the border portions. As mentioned above, the thickness of the cell spacer is greatest at the center portion and smaller at the border portions. Thus, referring to an axis perpendicular to the alignment axis, the thickness of the cell spacer decreases the farther the distance along said perpendicular axis is from a center of the cell spacer. Decreasing continuously may refer to a steady decrease, for example, without steps (e.g., discrete steps). In other words, the cell spacer becomes continuously thinner towards opposite ends. This results in a particularly stable shape of the cell spacer as the forces exerted by the adjacent battery cells may be particularly evenly distributed at the surface and inside the cell spacer. According to some embodiments, the cell spacer has an elliptical cross-section. The elliptical cross-section may be along the alignment direction. In other words, the cell spacer may have a bi-convex shape. A cell spacer of such a shape may be particularly stable and easy to manufacture.

According to some embodiments, the thickness of the cell spacer decreases in steps from the center portion to each of the border portions. As mentioned above, the thickness of the cell spacer is greatest at the center portion and smaller at the border portions. Thus, referring to an axis perpendicular to the alignment axis, the thickness of the cell spacer decreases the farther the distance along said perpendicular axis is from a center of the cell spacer. Decreasing continuously means a gradual decrease in multiple steps, for example, in at least two or at least three steps. Thus, in contrast to a continuous decrease as explained above, the cell spacer of such embodiments becomes thinner towards the end in multiple steps. This alternative also results in a particularly stable shape of the cell spacer as the forces exerted by the adjacent battery cells may be particularly evenly distributed at the surface and inside the cell spacer.

The present disclosure also pertains to an electric vehicle including said battery system.

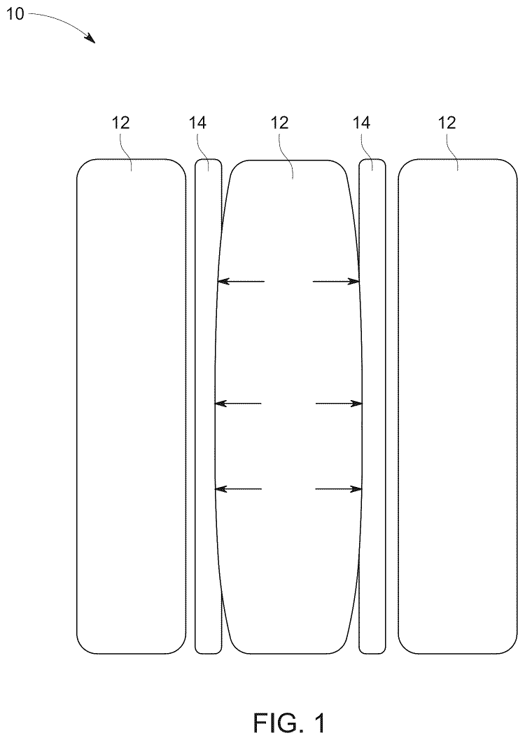

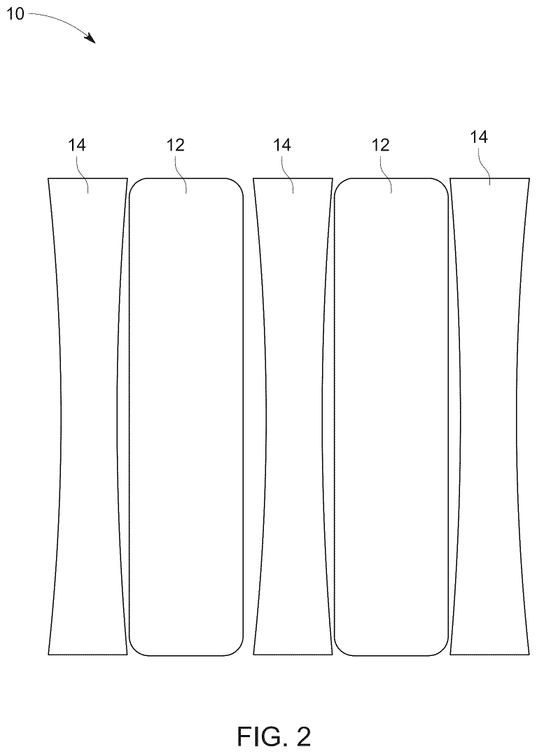

FIGS. 1 and 2 illustrate a battery system 10 according to some examples. The battery system 10 includes multiple battery cells 12 and cell spacers 14 which are alternately arranged. The cell spacers 14 can provide a space between adjacent battery cells 12 distancing the battery cells 12 from each other and limiting thermal conduction between the battery cells 12. The cell spacers 14 may limit thermal propagation via conduction between a faulty battery cell, for example, a battery cell experiencing a thermal runaway, and a healthy battery cell. The cell spacers 14 have a cuboid shape with a rectangular or substantially rectangular cross-section, as shown in the FIG. 1.

During their lifetime the battery cells 12 are charged and discharged numerous times, wherein the battery cells 12 swell up, that is, increase in thickness and thus volume, during charging, and shrink, that is, decrease in thickness and thus volume, during discharging. This kind of cyclic volume change is referred to as cell breathing. FIG. 1 shows the battery cell 12 in the middle of the battery system 10 in its swollen state in which the amount of increase in thickness is exaggerated for illustrative purposes. As indicated by the arrows, the swollen battery cell 12 exerts a force onto the adjacent cell spacers 14 on opposite sides of the swollen battery cell 12. The battery cells 12 generally swell up more at the center than at the edges.

As a result of the battery cells 12 swelling up, the cell spacers 14 get deformed over time as can be seen in FIG. 2, which shows the battery system 10 after numerous breathing cycles. With every breathing cycle the battery cells 12 compress the cell spacers 14 thereby gradually reducing their thickness over time. As the battery cells 12 swell up more at the center than at the edges, the cell spacers 14 develop a concave shape with a reduced thickness in the middle as shown in FIG. 2. These deformed cell spacers 14 can no longer sufficiently perform their intended purpose of distancing the battery cells 12 and limiting thermal conduction between the battery cells 12 which may prove disadvantageous for structural integrity of the battery system 10.

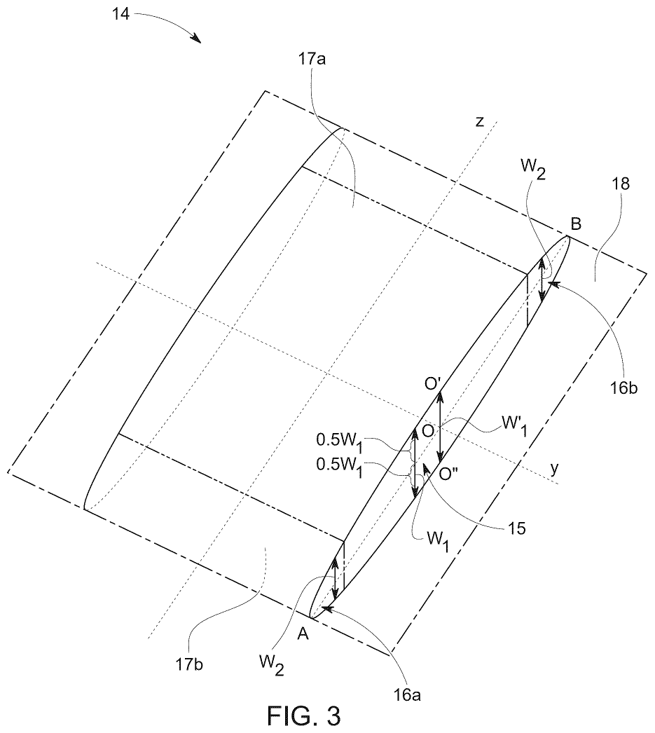

Some embodiments of the present disclosure overcome this problem with battery systems 100 and 100′ and cell spacers 14 shown in FIGS. 3 to 5.

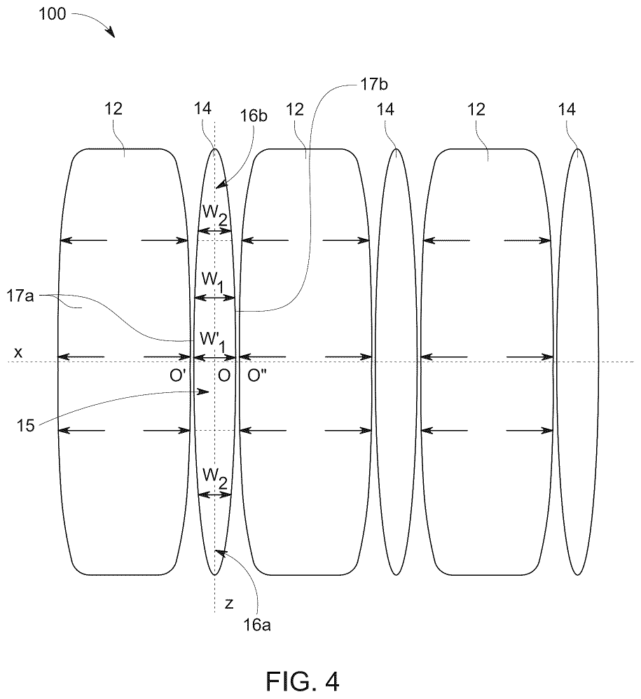

FIGS. 3 and 4 illustrate a cell spacer and a battery system 100 including the same, according to some embodiments of the present disclosure. The battery system 100 shown in FIG. 4 includes a plurality of prismatic battery cells 12 arranged along an alignment axis x, in which a cell spacer 14 is disposed between adjacent ones of the battery cells 12. In other words, the battery cells 12 and cell spacers 14 are alternately stacked along the alignment axis x. The battery cells 12, while being of prismatic shape in their regular state, are shown in their swollen-up state due to cell breathing as shown in FIG. 4.

FIG. 3 schematically illustrates a perspective view of the cell spacers 14. Referring to FIGS. 3 and 4, each cell spacer 14 has a mirror-symmetrical shape with a mirror symmetry plane that lies in the y-z plane and cuts centrally through the cell spacer 14. Thus, the mirror symmetry plane is a central plane 18. Each cell spacer 14 includes a center portion 15, and a lower border portion 16a and an upper border portion 16b adjoining the center portion 15. The center portion 15 has a greater thickness w₁ than the thickness w₂ of the adjoining border portions 16. The central plane 18 extends through the center portion 15 and border portions 16 along the z-axis. In some embodiments, each cell spacer 14 has an elliptical cross-section as shown in FIG. 4. The thickness of the cell spacer 14 decreases continuously (e.g., steadily) from the center portion 15 having the thickness w₁ (which is at its maximum value w₁′ when the distance is from point O′ to O″) to each of the border portions 16 where the thickness is at a smaller value w₂, that is, w₂<w₁. The thickness w₂ has a minimum value 0 at end points A or B. The thickness denotes the extension of the cell spacer 14 along the alignment axis x. As the cell spacers 14 are mirror-symmetrical with respect to the central plane 18 (or y-z plane), outer surfaces 17a and 17b of the cell spacer 14 are distanced the same amount from the central plane 18 but in opposite directions. Both the outer surfaces 17a and 17b may extend the same distance, that is, the distance of 0.5 w₁ at the center portion 15, from the mirror symmetry plane but in opposite directions along the alignment axis x. In FIG. 3, the ellipsoid shape of the cell spacers 14 may be exaggerated for illustrative purposes.

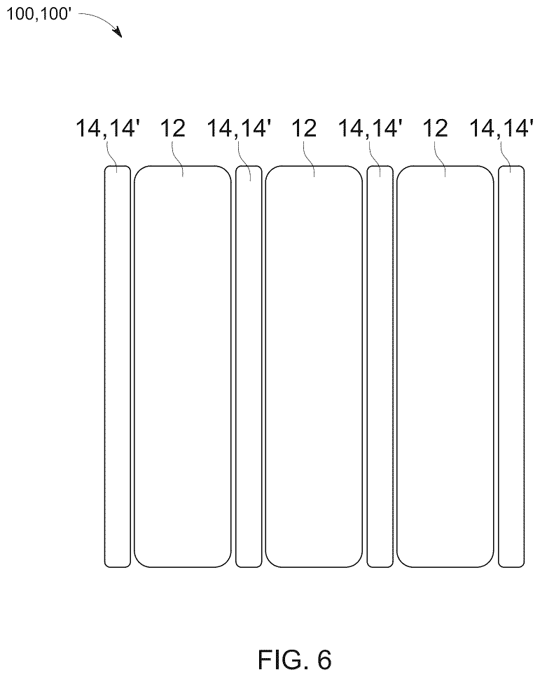

As mentioned, the battery cells 12 in FIG. 4 are shown in their swollen state. Here, the battery cells 12 exert pressure onto the adjacent cell spacers 14 as indicated by the arrows inside the battery cells 12. As a result, the cell spacers 14 are compressed and deformed. As the battery cells usually exert a larger force or pressure in their center than at the edges, a center portion 15 of a cell spacer 14 is compressed more than border portions 16a and 16b. As the cell spacers 14 are thickest at the center portion 15, that is, where the adjacent battery cells 12 exert the most pressure, the cell spacers 14 are better suited to withstand these forces. Nevertheless, after numerous breathing cycles the cell spacers 14 may become flattened. The cell spacers 14 are thereby, after numerous breathing cycles, formed into a cuboid shape having a rectangular or substantially rectangular cross-section as shown in FIG. 6. In this cuboid shape the cell spacers 14 may still perform their intended purpose of distancing the battery cells 12 and limiting thermal conduction between the battery cells 12 as the deformed cell spacer 14 contact the adjacent battery cells basically over their whole surface. Even in this deformed shape the cell spacer 14 ensures that a set or predefined distance between two adjacent/neighboring battery cells 12 is maintained.

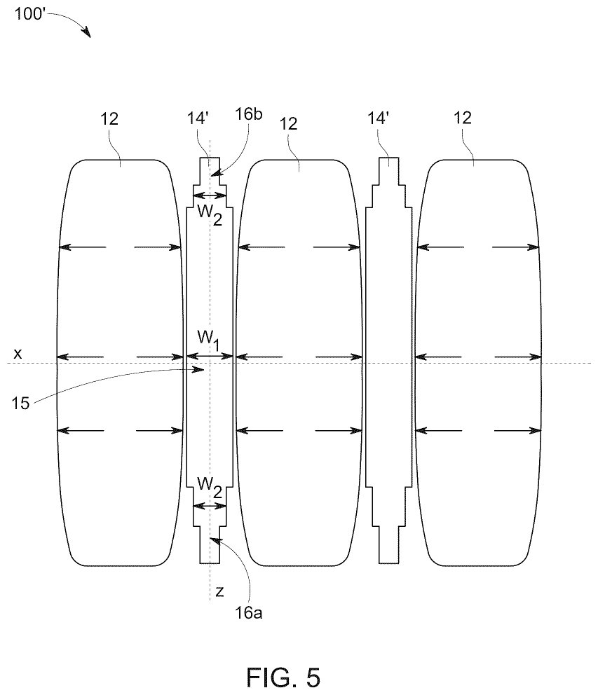

FIG. 5 illustrates a battery system 100′ according to some other embodiments of the present disclosure. The battery system 100′ differs from the embodiments described above in the shape of the cell spacers. The battery system 100′ includes a plurality of battery cells 12 arranged along an alignment axis x, wherein a cell spacer 14′ is disposed between adjacent ones of the battery cells 12. The cell spacer 14′ is also mirror-symmetrical with its mirror symmetry plane in the y-z plane, that is, the mirror symmetry plane is perpendicular to the x-axis and therefore the alignment axis. Also, the cell spacers 14′ include a center portion 15 and border portions 16 adjoining the center portion 15. The center portion 15 has a greater thickness w₁ than the thickness w₂ of the adjoining border portions 16.

In in the embodiments of FIG. 5, the cell spacers 14′ are not of an elliptical shape with a continuous decrease in thickness from the center portion to the border portions. Instead, the thickness of the cell spacers 14′ decreases in steps (e.g., gradually decreases in a stepped fashion) from the center portion 15 to each of the border portions 16. As shown in FIG. 5, the thickness is largest at the center portion 15 and decreases in at least one step at the border portions 16.

Similar to the cell spacers of the embodiments of FIGS. 3-4, the cell spacers 14′ become compressed by the battery cells 12 when the battery cells 12 swell up as shown in FIG. 5. Such a stepped shape of cell spacers 14′ may also be particularly suited to withstand the compression forces exerted by the battery cells 12. After numerous breathing cycles, however, the result may be the same as with the cell spacers 14 having the elliptical cross-section,. That is, the cell spacers 14′ may be flattened and may, in the end, be formed into a cuboid shape having a rectangular or substantially rectangular cross-section as shown in FIG. 6.

Thus, providing mirror-symmetrical cell spacers 14, 14′ which are thicker at their center portion 15 than at their border portions 16 allows for the cell spacers 14, 14′ to sufficiently perform their intended purpose of distancing the battery cells 12 and limiting thermal conduction between the battery cells 12 even after numerous breathing cycles.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

### Some of the Reference Numerals

10 known battery system
12 battery cells
14, 14′ cell spacers
15 center portion of cell spacers
16 border portions of cell spacers
16a lower border portion
16b upper border portion
17a outer surface
17b outer surface
100 battery system according to some embodiments of the present disclosure
100′ battery system according to some embodiments of the present disclosure

What is claimed is:

1. A battery system comprising:
a plurality of battery cells arranged along an alignment axis; and
a cell spacer in a gap between adjacent ones of the battery cells, the cell spacer comprising a center portion and border portions adjoining the center portion, the center portion having a greater thickness than the border portions,
wherein opposite outer surfaces of the cell spacer are arranged at a same distance but in opposite directions from a central plane, the central plane being perpendicular to the alignment axis and extending through the center portion and the border portions.

2. The battery system as claimed in claim 1, wherein the cell spacer has a mirror-symmetrical shape.

3. The battery system as claimed in claim 1, wherein a thickness of the cell spacer decreases continuously from the center portion to each of the border portions.

4. The battery system as claimed in claim 3, wherein the cell spacer has an elliptical cross-section.

5. The battery system as claimed in claim 1, wherein a thickness of the cell spacer decreases in steps from the center portion to each of the border portions.

6. An electric vehicle comprising the battery system as claimed in claim 1.
